(19) United States
(12) Patent Application Publication
(10) Pub. No.: US 2004/0183344 A1
(43) Pub. Date: Sep. 23, 2004

(54) Seat energy absorber

(76) Inventors: Patrick M. Glance, Plymouth, MI (US); Bradley M. Glance, Plymouth, MI (US)

Correspondence Address: Waters & Morse, P.C., 400 Ledyard Building, 125 Ottawa, Avenue, NW, Grand Rapids, MI, 49503, US

(21) Appl. No.: 10/735,553

(22) Filed: Dec. 12, 2003

Related U.S. Application Data
(60) Provisional application No. 60/432,863, filed on Dec. 12, 2002.

(51) Int. Cl. B60N 2/42

(52) U.S. Cl. 297/216.1

(57) ABSTRACT

A sliding energy absorbing vehicle seat bracket provides slide-forward seat travel at a controlled resistance force, which results in absorbing energy and limiting forces on a rear impacting occupant. The bracket can be a simple L-Section steel member with threaded stud attachment to the floor and shoulder rivet or shoulder bolt attachment to the seat or seat riser or pedestal. The shoulder rivet attachment fits in a slot in the bracket that permits resistive sliding of the seat relative to the vehicle floor. The slot can be shaped such that there is no sliding travel until a threshold force is reached and then the seat continues to slide with a continued resistance force. An interference fit of the slot to rivet can be provided by a tapered or serrated slot or a plastic insert molded in the slot. Other bracket designs include a U-shaped bracket or a horizontal slide instead of a vertical slot. The bracket has application for any vehicle seat where there are two or more rows of seats. Multiple row transit seating is a principal application.

### CROSS-REFERENCES TO RELATED APPLICATIONS

This is a non-provisional application based on and claiming the filing priority of co-pending provisional patent application Serial No. 60/432,863, filed Dec. 12, 2002.

### BACKGROUND OF THE INVENTION

The backs of automotive seat frames are impacted by rear seat occupants during vehicle frontal collisions. There is a Federal Standard (FMVSS 222) that limits the force produced on the rear-seated occupants for school bus seating, and requires a prescribed amount of energy absorption during seat tests. Current seats meet this requirement by bending and deforming the seat back frame at the prescribed load limit.

A problem arises with the use of seat-integrated restraints (SIR), because the seat back must be strong enough to withstand shoulder belt loads that are much higher than the school bus rear occupant load limit. This normally precludes the use of SIR seats in school bus applications.

A similar problem exists in passenger cars where rear seat occupants impact the back of front SIR seats. This can result in serious injuries to unbelted rear seat occupants.

An object of the present invention is to solve these problems and permit SIR seat usage without exceeding school bus rear occupant impact loading requirements.

### BRIEF SUMMARY OF THE INVENTION

The present invention comprises a sliding energy absorbing bracket that is designed to attach in between the seat riser (also referred to as a base or pedestal) and the vehicle floor. The bracket permits forward sliding movement of the seat frame upon application of a predetermined load such as would be experienced during a vehicle collision from a rear occupant impacting the front seat back.

The bracket can be a simple L-Section steel member with threaded stud attachment to the floor and shoulder rivet or shoulder bolt attachment to the seat riser. The threaded studs can be fixed to the floor, whereas the shoulder rivet attachment fits in a slot in the bracket to permit sliding of the seat relative to the vehicle floor.

The slot can be designed with a break-away and constant force feature such that there is no sliding travel until a threshold force is reached and then the seat continues to slide with a continued resistance force provided by virtue of design of the slot. One method to accomplish this is with an interference fit of the slot to rivet. A serrated slot or a plastic insert molded restraint in the slot also can be used.

Rear and front attachments can be employed to prevent rattle during normal seat use. Also, a resin coating or plastic sheet can be employed between the bracket and riser to prevent the two from rusting and locking together over time.

A principal feature of the present invention is to provide slide-forward seat travel at a controlled resistance force which results in absorbing energy and limiting forces on a rear impacting occupant for the length of slot travel. Such a construction can meet FMVSS 222 requirements and result in lower occupant g-loading (deceleration force).

The invention has application for any vehicle seat where there are two or more rows of seats and has application for SIR or non-SIR seating. Transit seating, where there are multiple rows of seating, would be a principal application for this energy absorbing sliding bracket invention.

Other variations in the design instead of an L-bracket are possible, including a U-shaped bracket, or a horizontal slide instead of a vertical slot. Such variations in design are covered in the spirit of the invention of a mechanical device that permits forward seat frame movement for the purpose of absorbing energy during a vehicle forward collision.

These and other features, objects, and benefits of the invention will be recognized by one having ordinary skill in the art and by those who practice the invention, from the specification, the claims, and the drawing figures.

### BRIEF DESCRIPTION OF DRAWINGS

FIG. 1 is a perspective view of the present invention.

FIG. 2 is a side elevational view of the present invention.

FIG. 3 is a partial side elevational view showing the attachment of the seat base to the floor and using a bracket having a serrated slot.

FIG. 4 is an end view of the invention shown in FIG. 3.

FIG. 5 is a side elevational view of the bracket of the present invention, showing a slot opening that is narrowed or tapered.

FIG. 6 is a force deflection diagram showing the seat back force/deflection curve at various points along the slot of FIG. 5.

FIG. 7 is a perspective view of a double wide seat employing the present invention and showing the use of either a U-shaped or L-shaped bracket attached between the bottom of the pedestal to the floor or an L-shaped bracket attached between the top of the pedestal and the seat frame.

FIG. 8 is a front elevational view of another embodiment of the present invention employed in a double seat frame system for a school bus or the like.

FIG. 9 is a side elevational view of the embodiment of FIG. 8, showing the seat frame in its normal, undeflected position.

FIG. 10 is a side elevational view showing the seat frame of the FIG. 8 in a forward position resulting from a rearward applied load.

FIG. 11 is a side elevational view of the seat frame of FIG. 8 showing the frame in a rearward position resulting from a forward applied load.

FIG. 12 is a side elevational view of the sliding bracket mechanism of FIGS. 8-11.

FIG. 13 is an end view of the sliding bracket mechanism of FIG. 12.

FIG. 14 is a perspective view of the sliding bracket mechanism of FIG. 12.

### DETAILED DESCRIPTION OF PREFERRED EMBODIMENTS

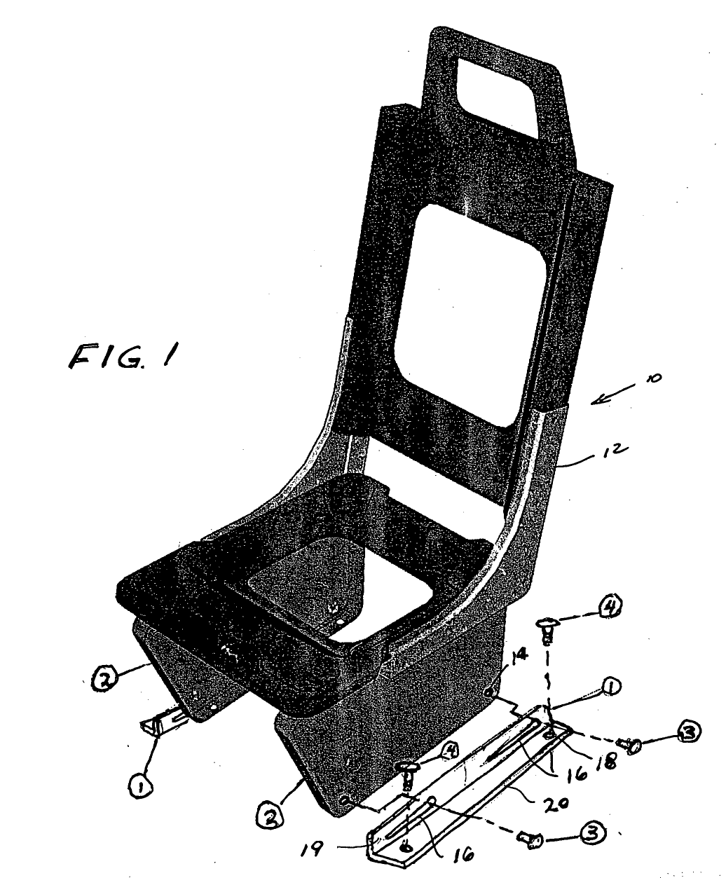

Referring to the drawings, a single seat 10 shown in FIG. 1 includes a seat frame 12 attached to a riser or pedestal or base 2. An L-shaped bracket 1 is attached to openings 14 at the lower side of the base by shoulder bolts or rivets 3 that extend through slots 16 in a vertical flange 19 in the bracket. The rivets permit sliding movement of the base with respect to the bracket. The base is fixed to the floor 5 by means of threaded studs 4 that fit through openings 18 in a lower horizontal flange 20 of the bracket are screwed to the floor.

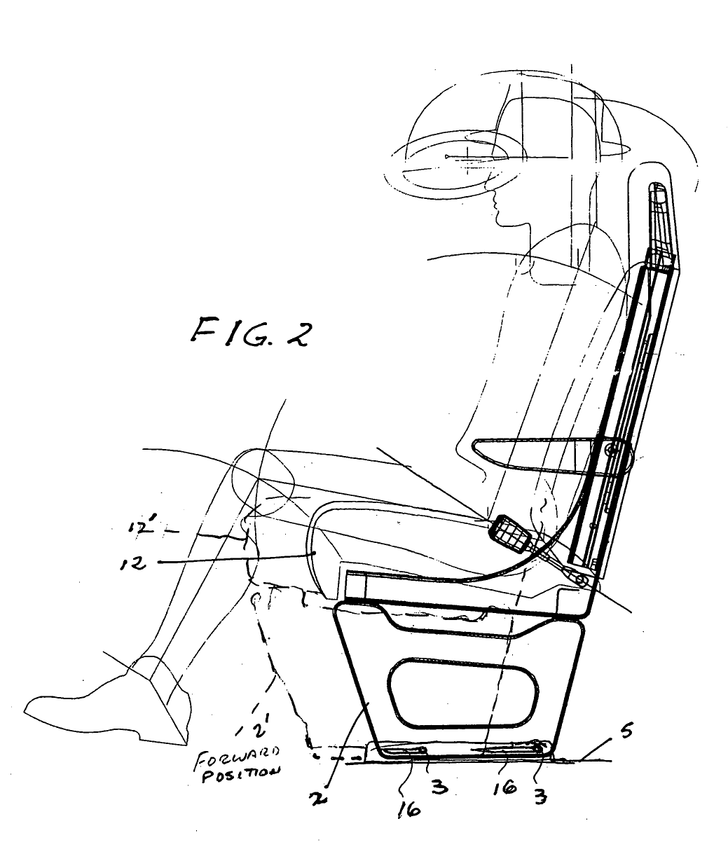

As shown in FIG. 2, when subjected to a frontal collision, seat base 2 and seat frame 12 slide forwardly to position 2′ and 12′ (shown in phantom) as rivets 3 slide forwardly through slots 16.

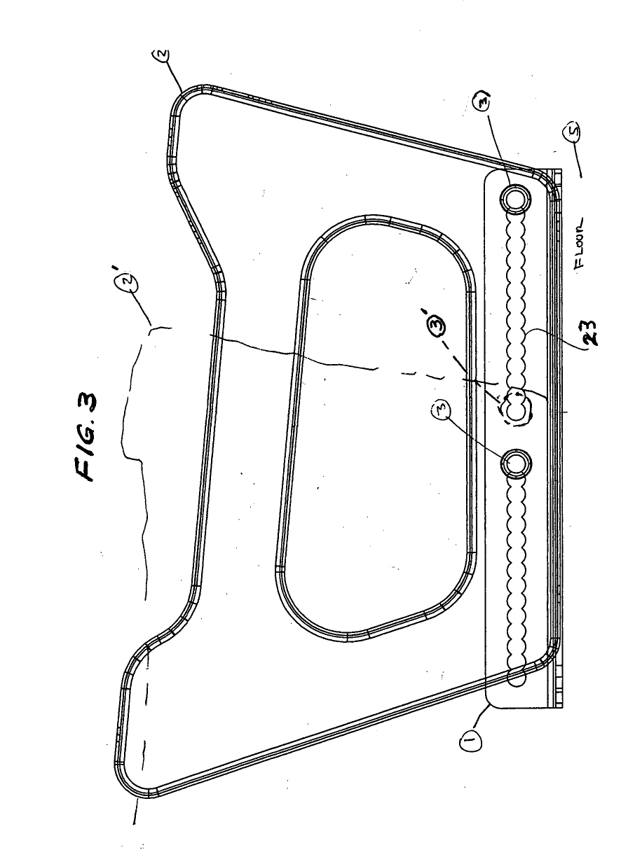

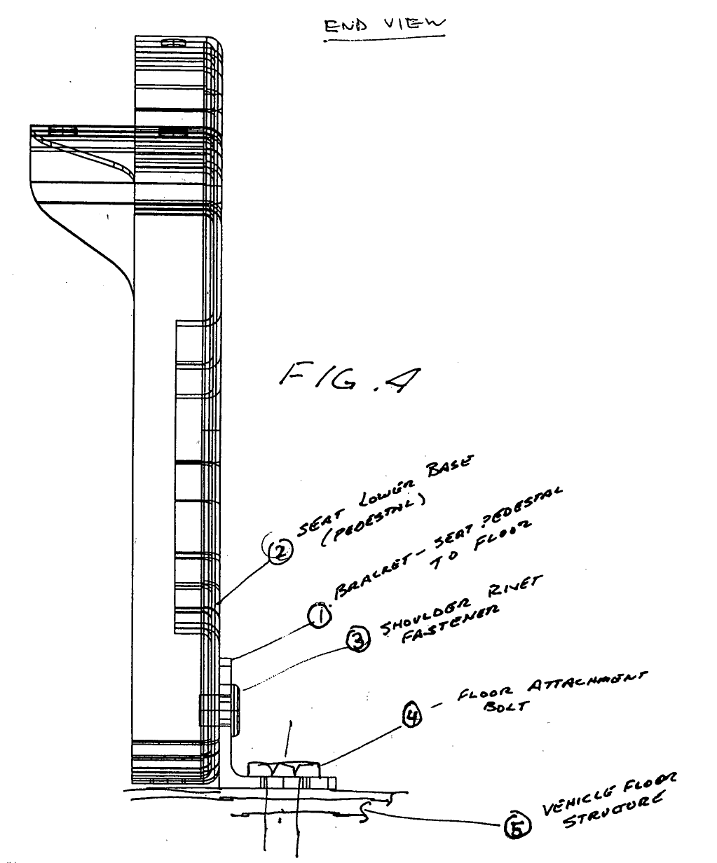

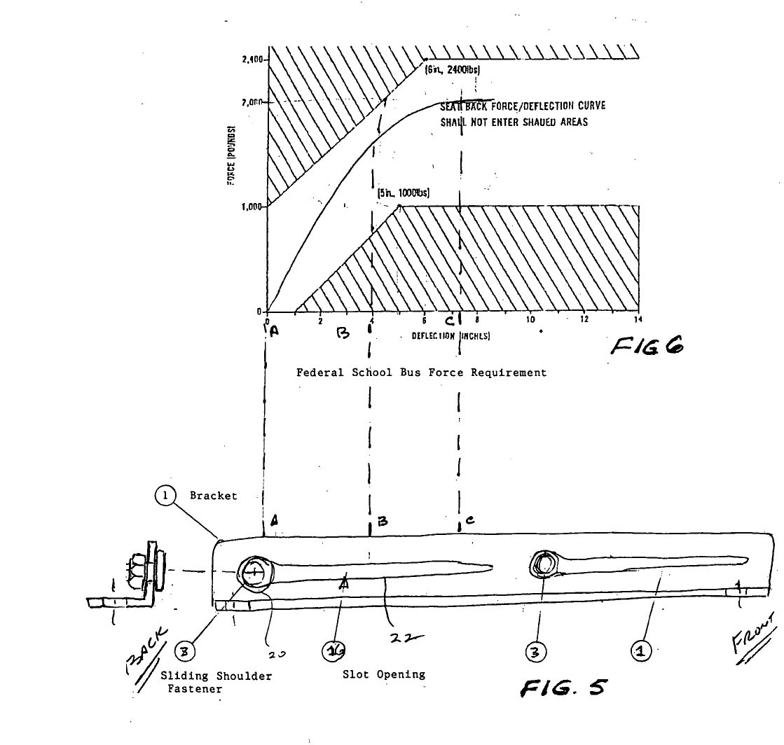

Slots 16 have an enlarged portion 20 at an upper end and a narrower portion 22 at the lower portion of the slot. A threshold force can be required to force the rivet from the upper portion 20 into the narrower portion 22 of the slot. The slot can be formed in a number of different ways in order to provide a continuous resistance along the slot. Several ways are shown in the drawings, such as a tapered slot 22 (FIGS. 1,2, and 5) or a serrated slot 23 (FIG. 3) or a slot that is simply narrowed or a slot that has a plastic insert that is effectively “extruded” by the rivet as it is forced along the slot.

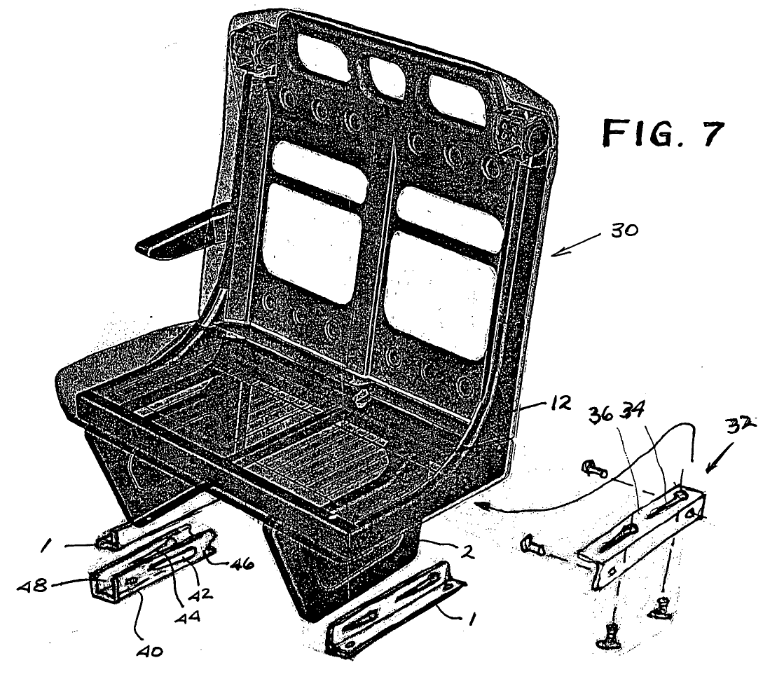

As shown in FIGS. 1 and 7, the invention can be employed with a single seat 10 or a multiple position seat, such as double seat 30. In addition, as shown in FIG. 7, a bracket 32 having its slot 34 in a horizontal upper flange 36 can be employed between the underside of seat frame 12 and pedestal 2 at the top of the pedestal, instead of a bracket 1, which is mounted between the floor and the bottom of the pedestal. Also, as shown in FIG. 7, an alternative U-shaped bracket 40 can be employed instead of the right angle bracket 1. Bracket 40 can fit over the base. A shoulder bolt or rivet can fit through slots 42 and 44 in opposite legs 46 and 48 or there may be only one slot and a shoulder bolt or rivet may fit through the slot into the base.

The foregoing is merely exemplary of the preferred practice of the present invention. Other ways of accomplishing the objectives of the present invention will occur to a person skilled in the art.

Another embodiment of the present invention is shown in FIGS. 8-14. In this embodiment, a seat 50 of the type used for a school bus seat or the like comprises a frame 52 covered by upholstery 54 and mounted on a pedestal 56. The pedestal has an elongated inner leg 58 that is adapted to be mounted on the floor 60 of a vehicle. A shorter outer leg 62 is adapted to be mounted on a bracket 64 attached to a vehicle sidewall 66. Legs 58 and 62 are mounted to the floor 60 or sidewall 66 of the vehicle by means of sliding brackets 68. For purposes of this invention the vehicle sidewall is considered as part of the floor

Brackets 68 include a downwardly facing U-shaped upper channel member 70 mounted on the lower end 72 of each leg. For convenience, only one leg is described, with the understanding that the brackets attached to both legs can be substantially identical.

Downwardly facing U-shaped channel member 70 fits in the interior of a upwardly facing U-shaped channel member 74, which is attached to the floor 60 (or to bracket 64) by means of bolts 76.

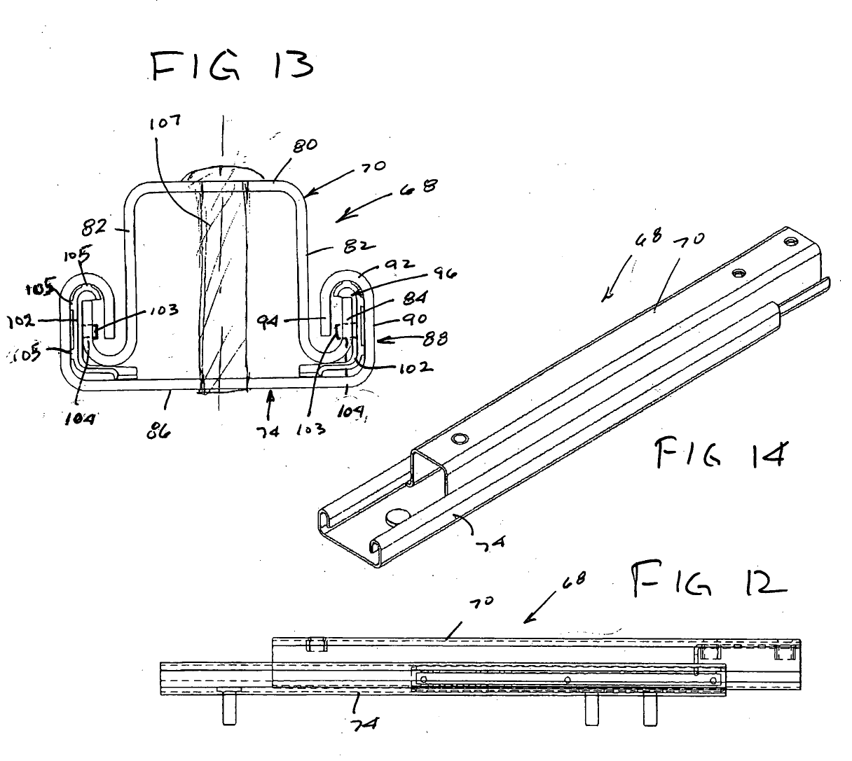

The construction of sliding bracket 68 is shown in more detail in FIGS. 12-14. Referring to FIG. 13, upper member 70 includes a horizontal central portion 80 and spaced legs 82 on each side thereof. Lower ends of legs 82 have outwardly and upwardly extending end portions 84. Lower U-shaped channel member 74 includes a horizontal central portion 86 and upwardly and inwardly extending legs 88 on opposite sides thereof. Legs 88 include an upwardly extending outer portion 90, an inwardly extending arcuate top portion 92, and a downwardly extending end portion 94, leaving an open interior cavity 96 between end portion 94 and outer portion 90. End 84 of upper bracket 70 fits in a cavity 96. Upper member 70 of the bracket is longitudinally slidable in lower member 74. An plastic liner 102 formed of a synthetic resin such as polyethylene is mounted on the exterior of end portion 84 and tightly fills the space between portion 84 and the interion of leg 88, causing a substantial interference fit between upper and lower members 70 and 74. Projections 103 on the interior surface of the liner fit in holes 105 in portions 84 of the upper member and lock them in place on the upper member. The upper member is mounted longitudinally into the lower member 74. Ridges 105 along the outer surface of the liner engage the interior of bottom channel member 74 when the two members are slid longitudinally together. This extrudes the ridges and causes a very tight fit, requiring as much as 1000 pounds of force or so to slide the upper member in the lower member. A shear pin 107 formed of plastic or other suitable material preferably locks the upper and lower members together until a threshhold force is reached. Then the shear pin is severed and the upper and lower members can slide in their tight interference fit. This produces a desirable force-deflection curve whereby the inpact force is dissapated by the resistance of the sliding bracket members.

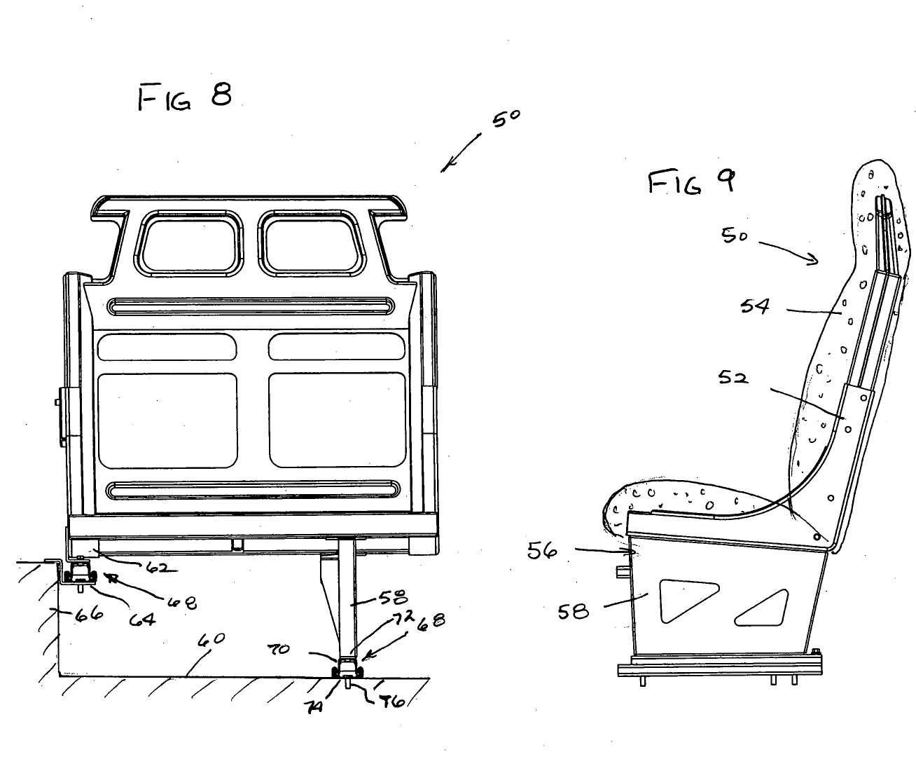

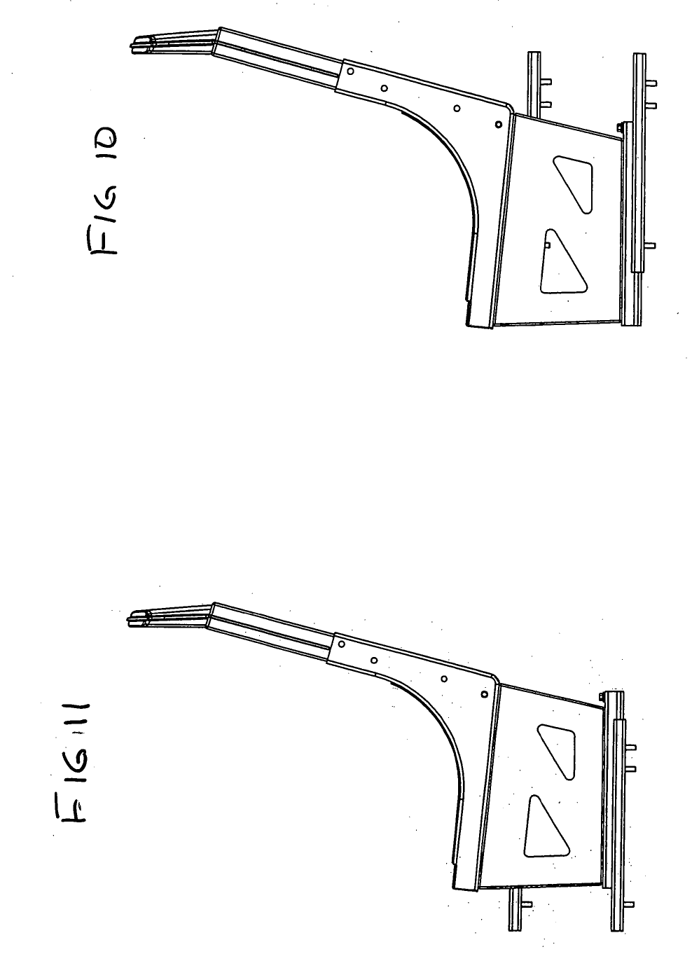

As shown in FIGS. 9, 10, and 11, the plastic liner holds the seat frame in its normal position, shown in FIG. 9, until an impact load requiring cushioning is received by the seat structure. When the load force urges the seat forwardly, as shown in FIG. 10, the resistance to movement provided by the plastic insert is overcome and the frame moves forwardly, as shown in FIG. 10. When the seat is urged in a rearward direction with the force exceeding a predetermined level that severs the shear pin, the seat slides rearwardly, as shown in FIG. 11. By providing a plastic liner between the upper and lower bracket members, the bracket can be adapted for resisting seat deflecting forces in both forward and reverse directions.

1. A mechanical device consisting of a seat lower base (pedestal) and a bracket attached to the vehicle floor. The attachment between the seat base and bracket permits sliding movement of the integral belted seat and occupant relative to the vehicle floor, thereby dissipating energy during a vehicle frontal collision and lower the g-force on both the belted occupant and the rear seated occupant who would impact the rear of the front seat frame.

2. A mechanical device as in feature 1 wherein the bracket is slotted and attached with a fastener such as a rivet or shoulder bolt to permit sliding travel.

3. A mechanical device as in feature 1 where the bracket is an L-cross section or U-cross section metal member.

4. A mechanical device as in feature 1 where the bracket is slotted with an interference fit to permit sliding movement at a prescribed force and continued resistance force.

5. A mechanical device in feature 1 where the sliding movement would have a break away feature to initiate sliding travel only at a predetermined force level.

6. A slide design in feature 1 where the slot is serrated to provide continued resistance force as a means to absorb energy during vehicle impact and seat travel.

7. A slide design as in feature 1 where the slot has a molded plastic insert that is “extruded” by the attachment rivet during seat to floor relative movement, thereby acting as an energy absorber.

8. A mechanical device consisting of a seat frame and pedestal where the energy absorber slot is located at the top of the pedestal instead of bottom of the pedestal to the floor.

9. A mechanical device as in feature 1 wherein the bracket has a slot that varies in size along its length, as by being narrowed or tapered from rear to front, to control the resistance force of the rivets sliding forward, thereby absorbing energy in the prescribed manner to meet the school bus standard.
